(19) United States
(12) Patent Application Publication
(10) Pub. No.: US 2009/0273114 A1
(43) Pub. Date: Nov. 5, 2009

(54) Block Making Mold Apparatus and Methods

(76) Inventor: David L. Moshel, Tucson, AZ (US)

Correspondence Address: QUARLES & BRADY LLP, ONE SOUTH CHURCH AVENUE, SUITE 1700, TUCSON, AZ, 85701-1621, US

(21) Appl. No.: 12/114,378

(22) Filed: May 2, 2008

(51) Int. Cl. B28B 7/10

(52) U.S. Cl. 264/163; 425/219; 425/193

(57) ABSTRACT

Apparatus and processes for block making that include a mold having a press foot disposed in vertically slidable arrangement within the mold. During a block making operation, the mold moves between positions, with the press foot remaining in the mold during movement. Because the press foot is part of the mold and not attached to a ram, a variety of blocks may be produced and stockpiled simultaneously. Also, perfect alignment between the press foot and the ram is unnecessary and easier to achieve than if the press foot leaves the mold, thereby simplifying the construction and operation of the machine and reducing the risk of damage.

### BACKGROUND OF THE INVENTION

1. Field of the Invention

This invention relates to an apparatus and process for improved manufacture of blocks of material.

2. Description of the Related Art

A typical brick is a block of ceramic material used in masonry construction and sized to be laid with one hand using mortar. Traditionally, bricks may be made from clay, shale, concrete and similar materials. Clay or clay-containing dirt probably is the most common material, with bricks being formed through a variety of processes.

Many machines and processes for making bricks have been proposed in order to reduce the labor costs involved. For example, U.S. Pat. No. 3,142,105 discloses a complex machine that excavates soil or clay to be used in the process of making bricks. In essence, bricks are formed by spreading wet adobe material or mud deposited from a hopper of the machine into a mold box that molds a set of blocks. The mold box is then raised, depositing the set of molded blocks on the recently excavated ground.

U.S. Pat. No. 2,787,040 discloses a mobile brick making machine that excavates soil and extrudes bricks that are discharged out of an opening and must be retrieved from the opening and located elsewhere for curing.

U.S. Pat. No. 4,515,549 discloses an automatic machine for pressing bricks at high speeds by utilizing a pressure wheel and pressing tongues attached to the circumference of the wheel through an axle that permits the tongues to rotate or swing about the axle. Clay material is fed to an endless belt having several molds, pressed by the pressure wheel, and then conveyed to a release station.

U.S. Pat. No. 4,640,671 discloses a three station turret-type apparatus that includes a first station having a structure for receiving a quantity of soil to be compressed into a building block, a second station for compressing the soil into the desired building block, and a third station for ejecting a formed building block from the apparatus. A rotary table is equipped with peripherally spaced sleeves for successive registry with the three station positions, each sleeve having a mold in which the desired block is to be formed. However, the components that press and eject the blocks are not integral with the molds, which means, among other things, that these components must be disassembled and changed, or different machines must be used, for making different kinds of blocks.

While each of the apparatus above may be suited to its intended purpose, there continues to be a need for improved apparatus and methods for making a variety of blocks from compressed material.

### SUMMARY OF INVENTION

The apparatus and methods of the invention relate to mobile block-making molds that are used with block-making machines and that contain a press foot that is used to compress and eject a block. Rather then remaining stationary, the press foot travels with the mold during a block-making operation.

In one embodiment, the mobile mold and press foot are coupled with a bottom-press reciprocating machine that utilizes dual action (i.e., a simultaneous press-extrude action), which allows for a much faster production rate than other bottom-press designs.

Preferably, the press foot is frictionally engaged by the mold such that it is slidable vertically within the mold but will not exit the bottom of the mold. Thus, a ram, such as a hydraulic press, engages the press foot but is not attached thereto, which leaves the press foot to move with the mold to the next operation.

Thus, in one embodiment of the invention, a block making apparatus of practically any configuration is capable of making a variety of different blocks simultaneously by having different press feet present in different molds.

In another embodiment, an apparatus of the invention further includes a removable spacer disposed upon a press foot. By either changing the press foot within the mold or adding one or more spacers, blocks of different sizes or configurations are readily produced. Moreover, the addition of a spacer can be accomplished without having to stop the apparatus and halt production.

In a method embodiment of the invention, the steps involved include filling a mold having a press foot disposed in vertically slidable arrangement within the mold with a block-forming material, wherein the press foot is contained from exiting the mold's underside, compressing the material through engagement of the press foot by a ram, and ejecting the compressed material from the mold through engagement of the press foot by a second ram.

The molds of the invention also are detachable. The detaching mold design enables the operator to easily remove the mold and press foot for mold changing or service by removing a pin and sliding the mold and press foot mechanism out of a block or brick making machine

Accordingly, the invention provides novel methods and apparatus for improved production of blocks or bricks.

### BRIEF DESCRIPTION OF THE DRAWINGS

FIGS. 1A and 1B schematically illustrate a side elevational view of a first embodiment of the invention, with the molds and drawers in cross-section to reveal interior components or content.

FIG. 2 schematically illustrates a top view of another embodiment of the invention, with the hoppers shown in phantom line.

FIG. 3 is a simplified schematic top view of a third embodiment of the invention.

FIG. 4 illustrates in side cross-sectional view the embodiment shown in FIG. 3.

FIG. 5 illustrates in front view a reciprocating machine embodiment that presses a block while extruding another block utilizing two exit rams and single press ram.

### DETAILED DESCRIPTION OF THE PREFERRED EMBODIMENTS

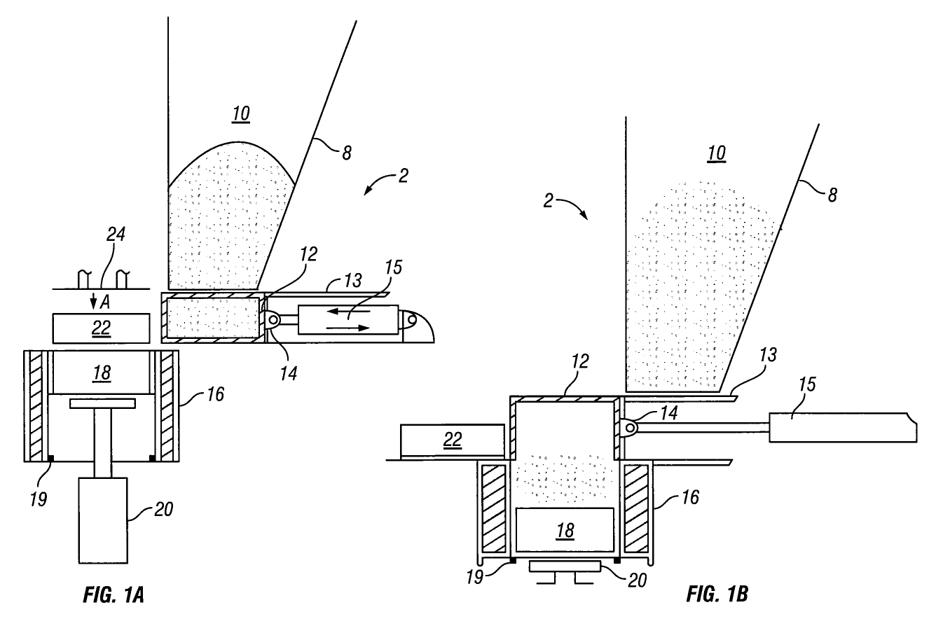

Turning to FIGS. 1A and 1B, a simplified drawing of a section of an improved automatic block-making apparatus 2 are shown. In FIG. 1A, the apparatus 2 is shown during a first operation, while FIG. 1B shows the same apparatus during a second operation. The apparatus 2 has a hopper 8 containing a block-making material 10 (such as clay or dirt), and a drawer 12. During the filling operation, drawer extension 13 covers the opening of hopper 8 to prevent material 10 from falling out. The drawer 12 is positioned to accept material 10 from hopper 8 and is coupled with driving means 14 (which in this case includes hydraulic cylinder 15). Driving means 14 moves the drawer 12 between a material loading position (FIG. 1A) and a material releasing position (FIG. 1B).

As shown in FIG. 1B, material 10 is released from drawer 12 into mold 16. Mold 16 includes a press foot 18 that receives and acts to compress material 10. Mold 16 is unique, in that the press foot 18 is disposed in vertically slidable arrangement within the mold but will not exit the mold bottom, which, in this case, is due to edge 19. In another embodiment, the mold may be more narrow at the bottom such that the press foot would be frictionally engaged and halted before exiting the bottom. Thus, the press foot 18 remains in the mold free from attachment to any other structure, such as press ram 20.

Press ram 20 is used in this embodiment to form a block 22 with material 10 by contacting press foot 18 and thereby compressing the material against a ram surface 24, which may be moved into position opposite press foot 18 as indicated by arrow A. Alternatively, mold 16 may be repositioned to a ram surface area prior to the compression operation as shown in subsequent embodiments.

An added feature of novelty is the ability of drawer 12 to scrape the top surface of press foot 18 during the unloading of material 10, thereby clearing block 22 from the press foot.

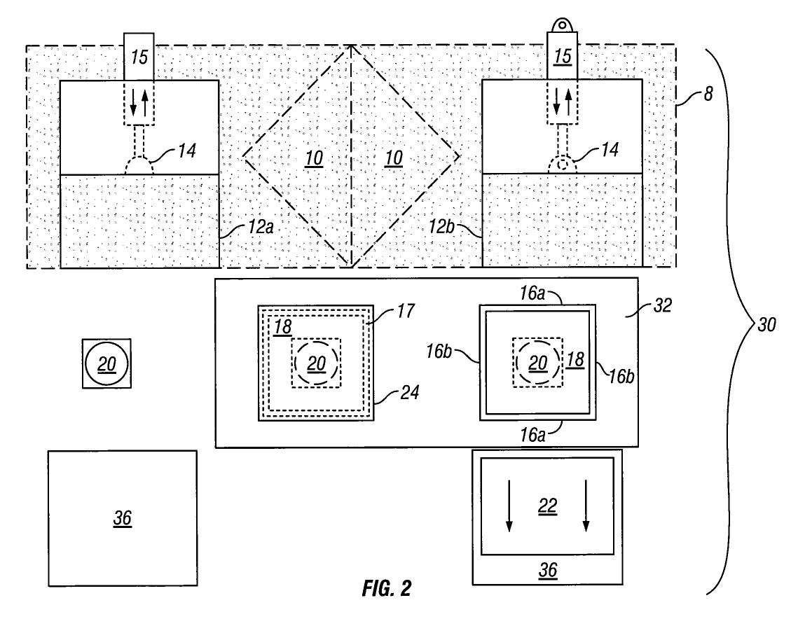

Turning to FIG. 2, wherein like numeric reference denote like parts from the previous embodiment, a top view of a block-making apparatus 30 is shown that includes a hopper 8 (shown in phantom line in contrast to the structures below the hopper) containing material 10 and drawers 12a and 12b for receiving the material. Apparatus 30 further includes a moving table 32 containing a pair of molds 16 and 17. Each mold has a pair of side-walls and a pair of end walls (for example, 16a and 16b) and includes a press foot 18 disposed in vertically slidable arrangement within the side and end walls.

Located beneath each mold and in one adjacent position are press rams 20. The two end press rams function as exit rams, in that they position a newly formed block 22 for exiting the mold 16 onto exit area 36, while the center press ram functions as a compression ram. The central compression ram is arranged to engage a press foot such that material 10 is compressed between the press foot and a compression surface 24 arranged opposite thereto.

Hence, in this embodiment, a drawer (12a, 12b) is loaded with material 10 and driving means 14 is actuated by hydraulic cylinder 15 such that the material is unloaded into a corresponding mold 16. Each mold 16 moves with table 32 between a first position to receive a fill material 10, and from which compressed block 22 is ejected from the mold, and a second position at which the compression is done. In other words, one block is extrudes and the mold is loaded with new material while the second mold undergoes compression to form a block. Thus, the press foot remains in remains in the mold during movement between the first and second positions and an efficient “reciprocal motion” apparatus is produced. The compression/ejection rams 20 and the exit rams 14 are controlled to work simultaneously so that when a block 22 is being formed, the already formed block is being pushed out of the mold to area 36. The central compression ram 20 retracts immediately after compressing the block. The end ejection rams 20 remains extended while the exit ram 14 pushes the block off the table until the charge of material in the drawer is directly over the mold at which time the eject ram 20 retracts, allowing the mold to fill with material. When the press foot 18 in the mold is fully retracted, the dirt drawer 12a or 12b retracts to its position under the hopper where it is filled again. When the drawer retracts fully the table moves to the next position where the process repeats.

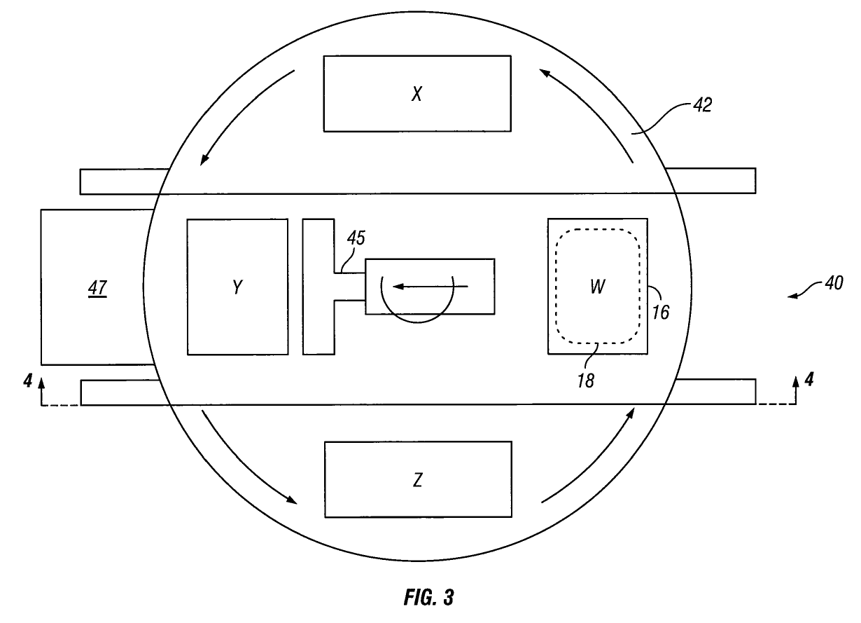

In FIG. 3, rather than a linear, reciprocal motion layout, an apparatus of the invention also may be configured as a rotary block-making machine 40. In this embodiment, a rotary table 42 has four stations having molds 16 and press feet 18 disposed therein. Each station or mold (denoted W, X, Y, and Z) undergoes a different operation (or no operation) depending on its position.

Thus, for example, mold W moves in to a first position to receive a fill material, a second position (formerly occupied by mold X) to compress the material, and then on to a third position from which the compressed material is removed from the mold surface by moving means 45 onto exit area 47. A fourth position (Z) is optionally included to provide a “rest position” at which no operation is performed or some different task, such as cleaning or inspection of the empty mold, etc. As with the previous embodiment, the press foot 18 in each mold 16 remains in the mold during movement between the first, second, third, and fourth position.

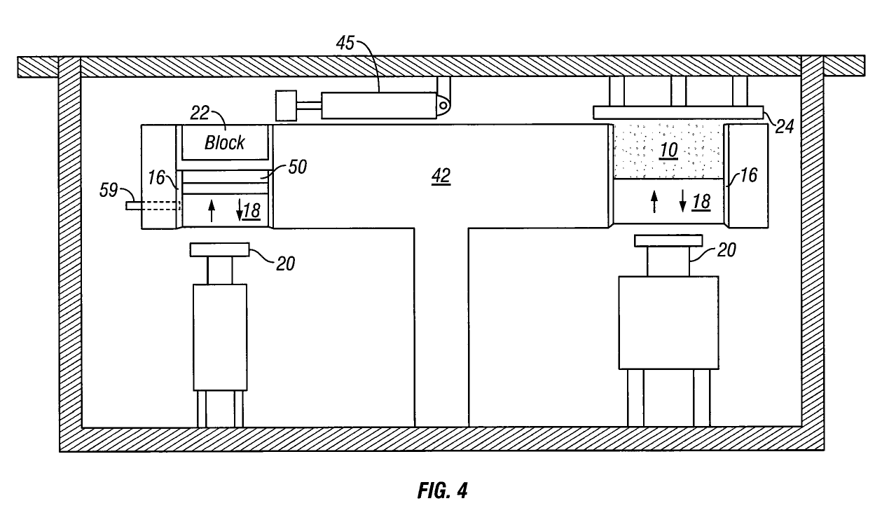

FIG. 4 shows the same embodiment as FIG. 3 in a cross-sectional side taken along line 4-4. As indicated by the numeric references, a block 22 is created through compression of material 10 by a press ram 20 acting upon press foot 18 inside a mold 16 and countered by ram surface 24. In addition, an insert 50 may be added to the mold 16 atop the press foot 18 to provide a means for producing a block with a different thickness and/or configuration.

Because the molds travel with a press foot, the rotary style machine has the added ability to produce 4 different blocks without changing molds. Moreover, a mold 16 may be detached from the machine for replacement, cleaning, or repair via removing pin 59. Thus, the detaching mold innovation greatly increases the versatility and usefulness of this machine.

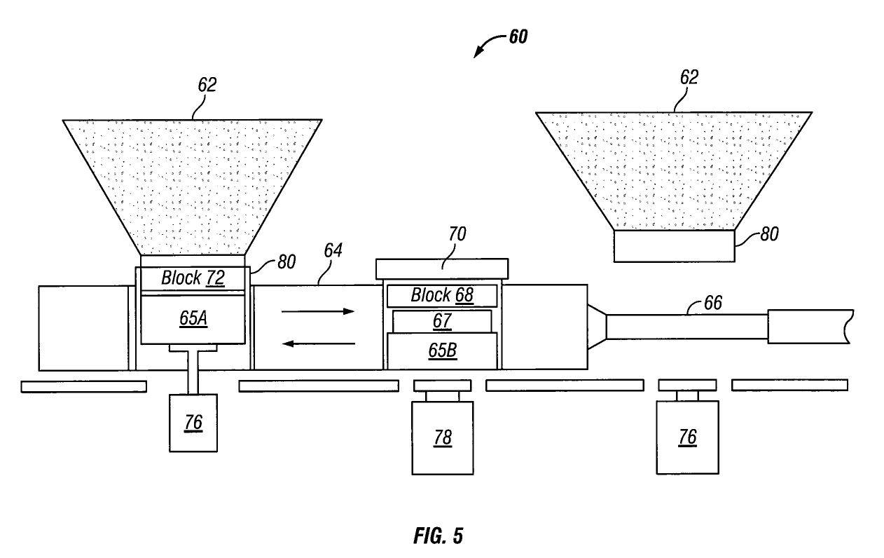

FIG. 5 illustrates in front view a reciprocating machine embodiment 60. Hoppers 62 feed a reciprocating form 64 having a pair of molds with press feet 65A and 65B actuated by hydraulic cylinder 66. Thus, the machine 60 presses a block 68 against press stop 70 while extruding another block 72 utilizing two exit rams 76 and single press ram 78. Because press foot 65B has a removable insert 67, it can produce a block that has a different thickness than that of press foot 65A. Thus, the “reciprocating mold” design has the ability to use a different size or shape of mold for each of the two molds, as the press foot only has to conform to the dimensions of the block mold it is situated in. This allows for the machine to produce two different blocks at the same time without changing molds and having the blocks exit the machine at two separate points. As in FIG. 1, a drawer 80 moves at 90 degrees relative to the action of the exit rams 76, which discharges each newly formed block from machine 60 and provides a new charge of material from hoppers 62.

Among other advantages of the embodiments above, blocks made with a machine that extrudes the block upwards after compression have less breaking of the blocks, produce a higher quality block and have a greater range of soil types, as the blocks do not need to withstand the shock of being extruded downward and dropping on to a tray or conveyor. In other words, the block receives very little jarring and shock during the production process, resulting in less breakage and a cleaner appearance (i.e., less chipping and fractures).

In view of the foregoing, a method for making blocks of material is provided. In a preferred embodiment, the method includes the steps of: (a) filling a mold having a press foot disposed in vertically slidable arrangement within the mold with a block-forming material, with the press foot being contained from exiting the mold's underside; (b) compressing the material through engagement of the press foot by a ram; (c) repositioning the mold and the press foot to a second location; and (d) ejecting the compressed material from the mold through engagement of the press foot by a second ram.

In addition, the method may include scraping the top surface of the press foot to thereby removing the compressed material therefrom. Especially preferred is when the scraping step includes simultaneously refilling the mold with a new charge of material.

Various changes in the details that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. An improved automatic block-making apparatus having a mold to receive and compress fill material, the improvement comprising a press foot disposed in vertically slidable arrangement within said mold, wherein said press foot remains in said mold free from attachment to a press ram.

2. The block-making apparatus of claim 1, where said mold moves between a first position to receive and compress said fill material and a second position from which compressed material is ejected from the mold, wherein said press foot remains in said mold during movement between said first and said second position.

3. The block-making apparatus of claim 1, wherein said mold moves between a first position to receive said fill material, a second position to compress said fill material, and a third position from which compressed material is ejected from the mold, wherein said press foot remains in said mold during movement between said first, second, and third position.

4. The block making apparatus of claim 1, further including a drawer for providing a charge of material to the mold, wherein said drawer is arranged to scrape a top surface of said press foot simultaneously with providing said charge of material.

5. The block making apparatus of claim 1, further including a removable spacer disposed upon said press foot.

6. The block-making apparatus of claim 1, wherein said press foot is removable from said mold.

7. The block-making apparatus of claim 1, wherein said mold is removable from said apparatus.

8. A block-making apparatus, comprising:
a hopper;
a drawer for receiving material from said hopper;
a driving means coupled with said drawer for moving the drawer between a loading and an unloading position;
a mold for receiving said material from said drawer, the mold having a pair of side-walls and a pair of end walls and including a press foot disposed in vertically slidable arrangement with said side and end walls, wherein said press foot remains in said mold free from attachment to an additional structure;
a press ram arranged to engaged said press foot; and
a compression surface arranged to contact a top surface a said material during compression in said mold.

9. The apparatus of claim 8, wherein said press foot is removable from said mold.

10. The apparatus of claim 8, wherein said mold is removable from said apparatus.

11. The apparatus of claim 8, further including a second mold having a pair of side-walls and a pair of end walls and including a press foot disposed in vertically slidable arrangement with said side and end walls, wherein said press foot remains in said mold free from attachment to a further structure, and driving means for positioning said mold and second mold between a first position and second position such that one mold is loaded with material while the second mold undergoes compression.

12. The apparatus of claim 8, further including a removable spacer disposed upon at least one press foot.

13. A method for making blocks of material, said method comprising the steps of:
(a) filling a mold having a press foot disposed in vertically slidable arrangement within said mold with a block-forming material, wherein the press foot is contained from exiting the mold's underside;
(b) compressing said material through engagement of said press foot by a ram;
(c) repositioning said mold and said press foot to a second location; and
(d) ejecting said compressed material from said mold through engagement of said press foot by a second ram.

14. The method of claim 13, further comprising the step of scraping a top surface of said press foot and thereby removing said compressed material therefrom.

15. The method of claim 13, wherein said scraping step comprises simultaneously refilling said mold with a new charge of material.

16. The method of claim 13, wherein said steps are performed on a linear block-making machine.

17. The method of claim 13, wherein said steps are performed on a rotary block-making machine.

18. The method of claim 13, further including the step of placing a spacer upon said press foot in said mold prior to step (a).
